(19) United States
(12) Patent Application Publication
(10) Pub. No.: US 2007/0280334 A1
(43) Pub. Date: Dec. 6, 2007

(54) METHOD AND DEVICE FOR DYNAMIC SPECTRUM MANAGEMENT OF xDSL UPSTREAM AND DOWNSTREAM SHARED FREQUENCY

(75) Inventors: Zhipeng Lv, Shenzhen (CN); Jianhua Liu, Shenzhen (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Huawei Technologies Co., Ltd., Shenzhen (CN)

(21) Appl. No.: 11/612,965

(22) Filed: Dec. 19, 2006

(30) Foreign Application Priority Data
May 30, 2006 (CN) 200610083512.4

(51) Int. Cl. H04B 1/69

(52) U.S. Cl. 375/133

(57) ABSTRACT

The present invention discloses a method of xDSL upstream and downstream shared frequency dynamic frequency spectrum management comprising the following steps: Step a. Generate all feasible combinations of subchannels in both upstream and downstream directions for an xDSL line; Step b, Determine which combination of said combinations has an optimal spectrum coordination; and Step c) Adjust direction of transmission and transmit power of the xDSL line according to said optimal combination. The present invention also discloses an xDSL upstream and downstream shared frequency dynamic frequency spectrum management device.

### CROSS-REFERENCES TO RELATED APPLICATIONS

The present application claims priority to Chinese Patent Application No. 200610083512.4, filed May 30, 2006, commonly assigned, incorporated by reference herein for all purposes.

### BACKGROUND OF THE INVENTION

The present invention relates to network communication technologies and particularly a method and device for xDSL upstream and downstream shared frequency dynamic frequency spectrum management.

xDSL (Digital Subscriber Line, abbreviated as DSL and xDSL refers to a variety of digital subscriber line) is a type of high data rate digital transmission technology on telephone twisted pair (Unshielded Twisted Pair, UTP). After many years of development, it has developed from first generation ADSL (Asymmetric Digital Subscriber Line) to second generation ADSL2, ADSL2+ and VDSL (Very-high-data-rate Digital Subscriber Line), and VDSL2. ADSL and VDSL is a multi-carrier system, it adopts Discrete Multi Tone (DMT) modulation and divides the frequency domain into multiple non-overlapping subchannels, each of which is designated for upstream or downstream transmission. Each subchannel corresponds to a different carrier frequency and each carrier frequency is modulated using QAM modulation. Dividing the frequency domain in this way simplifies DSL design.

FIG. 1 is a schematic diagram illustrating a reference model for an xDSL system (100);

As shown in FIG. 1, the DSLAM (120) comprises a subscriber end transceiver module (122) and separator/integrator (124). In the upstream direction, the subscriber end transceiver module (122) receives DSL information from the computer (110) and amplifies the received signal, and then sends the amplified DSL signal to the separator/integrator (124). The separator/integrator (124) integrates the DSL signal from the subscriber end transceiver module (122) and the POTS signal from the telephone terminal (130). The integrated signal is then transmitted through multiple UTP (140) circuits and is received by the separator/integrator (152) in the DSLAM (150) at the opposite end. The separator/integrator (152) separates the received signal, sends the POTS signal to the Public Switched Telephone Network (PSTN) (160) and sends the DSL signal to the transceiver module (154) of DSLAM (150). The transceiver module (154) re-amplifies the received signal then sends it to the network management system (abbreviated to NMS) (170). In the downstream direction, the signal is transmitted by the reverse of this process.

FIG. 2 is a schematic diagram illustrating three main types of VDSL2 frequency spectrum division;

xDSL technology separates the entire frequency spectrum into an upstream (subscriber to exchange) section and a downstream (exchange to subscriber) section. Upstream and downstream bandwidth is non-overlapping and mutually independent. ADSL (ADSL2) uses the frequency spectrum below 1.1 MHz, 25 kHz˜138 kHz is used for upstream and 138 kHz˜1.1 MHz is used for downstream. This allows a maximum upstream data rate of 800 kbps (1.5 Mbps) and a maximum downstream data rate of 8 Mbps (16 Mbps). ADSL2+ extends the downstream frequency spectrum to 2.2 MHz, and can provide a maximum of 25 Mbps downstream data rate and maximum of 3 Mbps upstream data rate. VDSL uses a maximum frequency spectrum of 12 MHz and can provide a maximum of 52 Mbps downstream data rate and a maximum of 26 Mbps upstream data rate. VDSL2 uses a frequency spectrum of up to 30 MHz and provides a symmetrical maximum upstream and downstream data rate of 100 Mbps. G. 993.2 gives frequency domain division between 0-12 MHz and between 12 MHz-30 MHz. As shown in FIG. 2, there are currently three main types of frequency domain division.

FIG. 3 is a schematic diagram illustrating FEXT crosstalk and NEXT crosstalk;

Subscriber cabling basically comprises multiple (25 pairs or above) twisted pairs. A variety of different services may be run on each twisted pair. Different kinds of xDSL will create crosstalk between each other when working, and in some of these circuits, performance may drop drastically because of this crosstalk. When the line is quite long, some circuits basically cannot put any form of DSL into service. Crosstalk is the main factor affecting subscriber data rate in current DSL Modem (e.g. ADSL, VDSL) systems, and can be divided into far end crosstalk (FEXT) and near end crosstalk (NEXT), as shown in FIG. 3. Usually, the effect of NEXT is greater than that of FEXT, but in ADSL/VDSL, because upstream and downstream frequency segregation and frequency multiplexing is used, the effect of FEXT is far greater than that of NEXT; this is especially true in environments using a combination of CO/RT.

As shown in FIG. 3, because xDSL upstream and downstream channels adopt frequency division multiplexing, near end crosstalk (NEXT) does not overly compromise system performance; however, far end crosstalk (FEXT) severely affects line transmission performance. When a cable contains many subscriber circuits that all require xDSL service, far end crosstalk (FEXT) will cause certain of those circuits to have a low data rate, unstable performance, and even the inability to establish the service. At the end, this may result in a low rate of line output at the DSLAM.

FIG. 4 is a schematic diagram illustrating the technology for a combined CO/RT environment.

xDSL eliminates or reduces crosstalk by regulating the transmission power of each frequency band in order to help improve the data rate. The conventional model of regulating transmission power is called static spectrum management: it includes Flat Power Back-Off, the Reference PSD Method, Reference Noise Method, and so on. Dynamic Spectrum Management (DSM) was proposed in recent years as a method to more effectively manage power allocation. It overcomes the defects of static spectrum management by dynamically regulating to eliminate or reduce the effect of crosstalk between each subscriber. Especially in a situation where a CO/RT combination is used as the effect of short line to long line crosstalk is significant. As shown in FIG. 4, the crosstalk from line 2 to line 1 is far greater than that from line 1 to line 2. The dynamic spectrum management method can greatly reduce the effect of crosstalk and consequently improves data rate.

DSM technology is yet to be applied commercially. FIG. 5 shows a schematic diagram illustrating a reference model for DSM related technology. At present, the mainstream structure for the first layer of DSM is as shown in FIG. 5. It has a Spectrum Maintenance Center (SMC) and three control interfaces, respectively DSM-S, DSM-C, and DSM-D. The SMC reads operating parameters for the DSL line from DSL-LT via the DSM-D interface then exchanges data with its related SMC via the DSM-S interface. When the SMC has sufficient information, it performs a series of optimization algorithms and finally sends control parameters to make the line operate optimally.

Specifically, DSM automatically regulates the transmit power of each modem in the entire network to eliminate crosstalk. Especially in an environment with a combination CO/RT application as the effect of short line to long line crosstalk is significant. As shown in FIG. 4, the effect of line 3 on line 1 is far greater than that of line 1 on line 3. The aim of DSM is to achieve a balance between maximizing the data rate of each modem and reducing its crosstalk effect on other modems.

In the existing xDSL standard, BIT table items and GAIN table items are used to indicate the bit rate and transmit power that can be carried by each carrier. Bit swapping technology achieves its aim by regulating the items in these two tables.

BIT table items are as shown in Table 1:

TABLE 1
Bit Table

| TONE1 | TONE2 | TONE3 | TONE4 | . . . | TONE NSC-1 |
|---|---|---|---|---|---|
| b1 | b 2 | b 3 | b 4 | . . . | b NSC-1 |

In the table, each bit table value ‘b’ represents the number of bits that can be carried in the corresponding xDSL line sub-frequency range ‘TONE’. The standard stipulates a maximum of 15 in any item. The size of said number of bits determines the line speed for the corresponding sub-frequency range. Modifying the size of items in the BIT table can change the line speed of said sub-frequency range.

In practice, a BIT table item determines a single speed for one line. On the other hand, the line speed can be obtained from many different BIT table items, of which in certain preconditions there is only a single optimal BIT table item.

GAIN table items are as shown in Table 2:

TABLE 2
GAIN Table

| TONE1 | TONE2 | TONE3 | TONE4 | . . . | TONE NSC-1 |
|---|---|---|---|---|---|
| g 1 | g 2 | g 3 | g 4 | . . . | g NSC-1 |

In the table, each gain table value ‘g’ represents the data transmit power of the corresponding sub-frequency range ‘TONE’ in the xDSL line. The size of said power determines the data volume carried in the corresponding sub-frequency range. Modifying the size of items in the GAIN table changes the data transmit power of said sub-frequency range.

Even though the DSM method greatly reduces crosstalk through regulating transmission power, with users requiring faster speeds and ever more diverse requirements, their demand for upstream and downstream data rates change dynamically with actual applications. Existing DSL technology uses a fixed bandplan design, i.e. each subchannel is designated for upstream or downstream transmission in advance. However, in practice, subscriber demand for upstream and downstream transmission changes and varies, depending on the subscriber's actual application. This limitation makes the line unable to satisfy diverse subscriber requirements.

Therefore, people need a dynamic frequency spectrum management scheme that can dynamically regulate the data rate of each subscriber line based on subscriber demand.

### BRIEF SUMMARY OF THE INVENTION

The present invention provides an xDSL upstream and downstream shared frequency dynamic frequency spectrum management method and device that dynamically regulates line transmission direction and transmits power based on actual subscriber requirements through Bandplan Design and Spectrum Coordination. Subscriber requirements for dynamically changing upstream and downstream data rate are thereby achieved and it effectively overcomes the limitations of upstream and downstream frequency in existing xDSL technology.

One aspect of the present invention presents a method of xDSL upstream and downstream shared frequency dynamic frequency spectrum management comprising the following steps: Step a) Generate all feasible combinations of subchannels in both upstream and downstream directions for an xDSL line; Step b) Determine which combination of said combinations has an optimal spectrum coordination; and Step c) Adjust direction of transmission and transmit power of the xDSL line according to said optimal combination.

In the aforementioned method of xDSL upstream and downstream shared frequency dynamic frequency spectrum management, Step a) comprises the following steps: Traverse each subscriber n=1, 2, . . . ,N and each combination of subchannel k=1, 2, . . . , K in the upstream and downstream directions to find out which combinations satisfy δ_{k,n}^{up}+δ_{k,n}^{down}=1 and δ_{k,n}^{up}, δ_{k,n}^{down}ε{0,1}, these combinations then serve as feasible upstream and downstream direction combinations. Where δ_{k,n}^{up} denotes whether the n^{th} subscriber and k^{th} subchannel is an upstream transmission, δ_{k,n}^{up}=1 denotes upstream transmission, (δ_{k,n}^{up}=0 denotes non-upstream transmission; δ_{k,n}^{down} denotes whether the n^{th} subscriber and k^{th} subchannel is a downstream transmission, δ_{k,n}^{down}=1 denotes downstream transmission, and δ_{k,n}^{down}=0 denotes non-downstream transmission.

In the aforementioned method of xDSL upstream and downstream shared frequency dynamic frequency spectrum management, step b) comprises the following steps: Step b1) Find the optimal power allocation scheme for each of the combinations; and Step b2) Compare each of the optimal power combinations to obtain the best power combination among the optimal power allocation schemes, and set the best power combination of the optimal power allocation schemes as optimal combination.

In the aforementioned method of xDSL upstream and downstream shared frequency dynamic frequency spectrum management, Step b1) comprises the following steps: Step 1 : Construct the mathematical model

$${J}_{k} = {w}_{1} {b}_{k}^{1 , up} + {w}_{2} {b}_{k}^{1 , down} + {\sum }_{n = 2}^{N} ( {λ}_{n}^{up} {b}_{k}^{n , up} + {λ}_{n}^{down} {b}_{k}^{n , down} ) - {\sum }_{n = 1}^{N} {μ}_{n} {s}_{k}^{n} ,$$

of which, sₖⁿ denotes the transmit power of the k^{th} subchannel in the n^{th} subscriber line; w₁ and w₂ are given fixed constants, λₙ^{up}, λₙ^{down} and μₙ are respectively Lagrange operators; bₖ^{n,up} and bₖ^{n,down} respectively denote the number of bits that can be carried in each of the upstream and downstream channels in the k^{th} subchannel of the n^{th} subscriber line; and Step 2: For each of the feasible upstream and downstream combinations, traverse sₖⁿ from 1 to K, applying δ as the minimum traversing interval, and with subchannel as the unit of recursion. Where, k=1, 2, . . . ,K and n=1, 2, . . . ,N, then through iteration find the power allocation scheme making Jₖ maximum and that satisfies the overall power limitation and data rate restriction for each subscriber line, then set that scheme as the optimal power allocation scheme.

In the aforementioned method of xDSL upstream and downstream shared frequency dynamic frequency spectrum management, Step 2) comprises the following steps:

Upon completion of traversing all subchannels, dynamically modify each weighting coefficient according to each of the following formulae:

$${λ}_{n}^{up} = {[ {λ}_{n}^{up} + ɛ ( {R}_{n , up}^{target} - {R}_{n}^{up} ) ]}^{+} , n = 2 , … , N$$

$${λ}_{n}^{down} = {[ {λ}_{n}^{down} + ɛ ( {R}_{n , down}^{target} - {R}_{n}^{down} ) ]}^{+} , n = 2 , … , N$$

$${μ}_{n} = {[ {μ}_{n} + ɛ ( {\sum }_{k = 1}^{K} {s}_{k}^{n} - {P}_{n} ) ]}^{+} , n = 1 , … , N ,$$

until satisfying the overall power and data rate limitations of each subscriber line and a stable state is achieved. The power allocation scheme thereof is the power allocation scheme making Jₖ maximum.

In the aforementioned method of xDSL upstream and downstream shared frequency dynamic frequency spectrum management, said Step 1 ) comprises the following steps:

When calculating Jₖ, obtain TONE noise σₖⁿ and channel attenuation function hₖ^{n,n} for the k^{th} TONE; the noise σₖⁿ comprises background noise of said xDSL line and crosstalk noise from other xDSL circuits, and the loading bit rate can be calculated according to

$${b}_{n}^{k} = {log}_{2} ( 1 + \frac{{\vert {h}_{k}^{n , n} \vert}^{2} {s}_{k}^{n}}{{\sum }_{m \neq n} {\vert {h}_{k}^{n , m} \vert}^{2} {s}_{k}^{m} + {σ}_{k}^{n}} ) .$$

Another aspect of the present invention provides a type of xDSL upstream and downstream shared frequency dynamic frequency spectrum management device, comprising: Bandplan Design Module, used to generate all feasible upstream and downstream subchannel combinations for an xDSL line; Optimal Combination Assessment Module, used to determine the optimal spectrum coordination combination from among the combinations; and Regulation Module, used to adjust the direction of transmission and transmit power according to said optimal combination.

In the aforementioned xDSL upstream and downstream shared frequency dynamic frequency spectrum management device, said bandplan design module traverses each subscriber n=1, 2, . . . ,N and each combination of subchannel k=1, 2, . . . , K in the upstream and downstream directions to find out which combinations satisfy δ_{k,n}^{up}+δ_{k,n}^{down}=1 and δ_{k,n}^{up}, δ_{k,n}^{up}ε{0,1}, these combinations then serve as the feasible upstream and downstream direction combinations. Where, δ_{k,n}^{up} denotes whether the n^{th} subscriber and k^{th} subchannel is an upstream transmission, δ_{k,n}^{up}=1 denotes upstream transmission, δ_{k,n}^{up}=0 denotes non-upstream transmission; δ_{k,n}^{down} denotes whether the n^{th} subscriber and k^{th} subchannel is a downstream transmission, δ_{k,n}^{down}=1 denotes downstream transmission, and δ_{k,n}^{down}=0 denotes non-downstream transmission.

In the aforementioned xDSL upstream and downstream shared frequency dynamic frequency spectrum management device, the optimal combination assessment module comprises: Spectrum Coordination Module, used to find the optimal power allocation scheme from each of the combinations; and Comparison Module, used to compare each of the optimal power allocation schemes, obtain the best power combination among the optimal power allocation schemes, and set the best power combination of the optimal power allocation schemes as optimal combination.

In the aforementioned xDSL upstream and downstream shared frequency dynamic frequency spectrum management device, the spectrum coordination module comprises:

Model Construction Module, used to construct the mathematic model

$${J}_{k} = {w}_{1} {b}_{k}^{1 , up} + {w}_{2} {b}_{k}^{1 , down} + {\sum }_{n = 2}^{N} ( {λ}_{n}^{up} {b}_{k}^{n , up} + {λ}_{n}^{down} {b}_{k}^{n , down} ) - {\sum }_{n = 1}^{N} {μ}_{n} {s}_{k}^{n} ,$$

of which, sₖⁿ denotes the transmit power of the k^{th} subchannel in the n^{th} subscriber line; w₁ and w₂ are given fixed constants, λₙ^{up}, λₙ^{down} and μₙ are respectively Lagrange operators; bₖ^{n,up} and bₖ^{n,down} respectively denote the number of bits that can be carried in each of the upstream and downstream channels in the k^{th} subchannel of the n^{th} subscriber line; and Traversing Module, used to traverse all sₖⁿ from 1 to K for each of the feasible upstream and downstream combinations, applying δ as the minimum traversing interval, and with subchannel as the unit of recursion. Where, k=1, 2, . . . ,K and n=1, 2, . . . , N, then through iteration find the power allocation scheme making Jₖ maximum and that satisfies the overall power limitation and data rate restriction for each subscriber line, then set this scheme as the optimal power allocation scheme.

In the aforementioned xDSL upstream and downstream shared frequency dynamic frequency spectrum management device, the traversing module is also used upon completion of traversing all subchannels to dynamically modify each weighting coefficient according to each of the following formulae:

$${λ}_{n}^{up} = {[ {λ}_{n}^{up} + ɛ ( {R}_{n , up}^{target} - {R}_{n}^{up} ) ]}^{+} , n = 2 , … , N$$

$${λ}_{n}^{down} = {[ {λ}_{n}^{down} + ɛ ( {R}_{n , down}^{target} - {R}_{n}^{down} ) ]}^{+} , n = 2 , … , N$$

$${μ}_{n} = {[ {μ}_{n} + ɛ ( {\sum }_{k = 1}^{K} {s}_{k}^{n} - {P}_{n} ) ]}^{+} , n = 1 , … , N$$

until satisfying the overall power and data rate limitations of each subscriber line and a stable state is achieved. This power allocation scheme is the power allocation scheme making Jₖ maximum.

In the aforementioned method of xDSL upstream and downstream shared frequency dynamic frequency spectrum management, said Step 1 ) comprises the following steps:

When calculating Jₖ, obtain subchannel noise σₖⁿ and channel attenuation function hₖ^{n,n} for the k^{th} subchannel; the noise σₖⁿ comprises background noise of the xDSL line and crosstalk noise from other xDSL circuits, and the loading bit rate can be calculated according to

$${b}_{k}^{n} = {log}_{2} ( 1 + \frac{{\vert {h}_{k}^{n , n} \vert}^{2} {s}_{k}^{n}}{{\sum }_{m \neq n} {\vert {h}_{k}^{n , m} \vert}^{2} {s}_{k}^{m} + {σ}_{k}^{n}} ) .$$

Through the aforementioned technical scheme, the present invention achieves the following results:

The present invention provides an xDSL upstream and downstream shared frequency dynamic frequency spectrum management method and device that dynamically regulates line transmission direction and transmits power based on actual subscriber requirements through Bandplan Design and Spectrum Coordination. Subscriber requirements for dynamically changing upstream and downstream data rate are thereby achieved.

Other characteristics and advantages of the present invention are elaborated on in the following specification. Moreover, some are easy to see from the specification or understand through the implementation of the present invention. The objectives and other advantages of this invention may be implemented and obtained from the text of the specification, claims, and specially referenced structures in attached figures.

### BRIEF DESCRIPTION OF THE DRAWINGS

The attached figures described herein are provided to further clarify the present invention and constitute an integral part of this application. The demonstrative implementation example and its specification are used to explain this invention and do not constitute any improper circumscription to the present invention. In the attached figures:

FIG. 1 is a schematic diagram illustrating a reference model for an xDSL system;

FIG. 2 is a schematic diagram illustrating the three main frequency spectrum division plans of VDSL2;

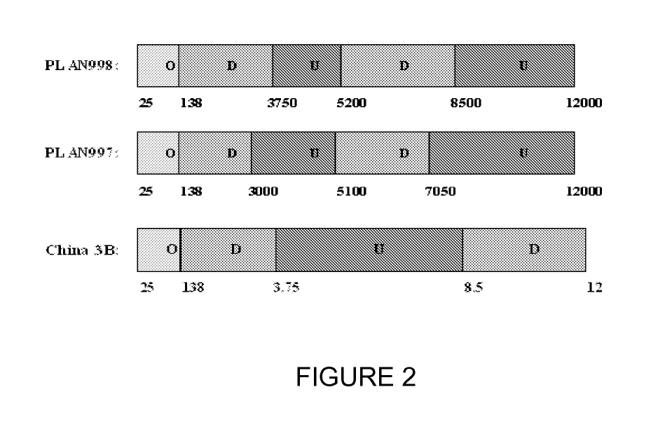

FIG. 3 is a schematic diagram illustrating FEXT and NEXT crosstalk in VDSL2;

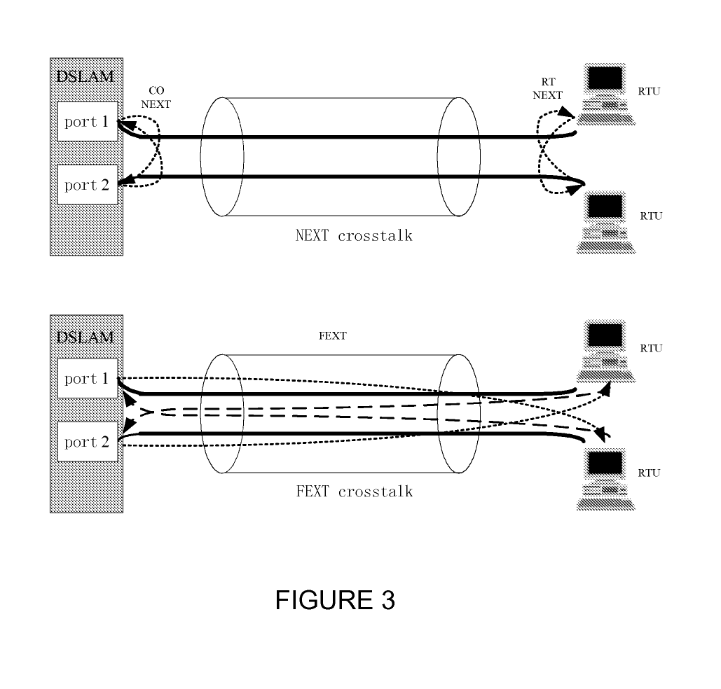

FIG. 4 is a schematic diagram illustrating a combined environment of CO/RT users;

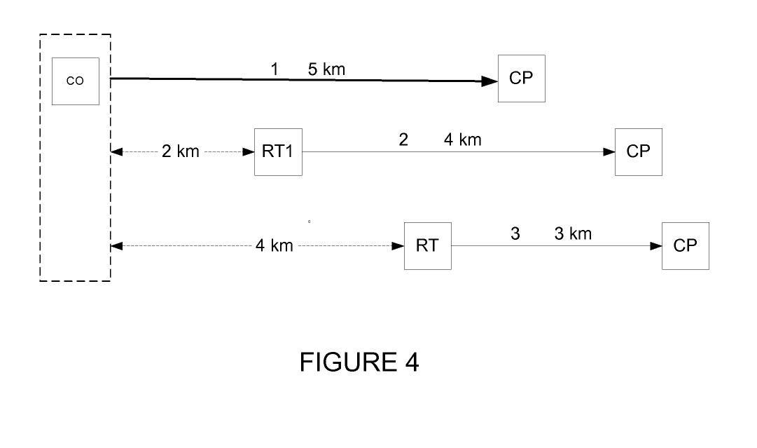

FIG. 5 is a schematic diagram illustrating a DSM reference model;

FIG. 6 is a schematic diagram illustrating a method for xDSL upstream and downstream shared frequency dynamic frequency spectrum management;

FIG. 7 is a schematic diagram illustrating a device for xDSL upstream and downstream shared frequency dynamic frequency spectrum management;

FIG. 8 is a schematic diagram illustrating an implementation example of a multi-subscriber environment for the present invention; and

FIG. 9 is a schematic diagram illustrating a method for xDSL upstream and downstream shared frequency dynamic frequency spectrum management for the multi-subscriber environment in FIG. 8.

### DETAILED DESCRIPTION OF THE INVENTION

Embodiments for Implementation

The following reference diagram specifies the present invention.

The idea behind the present invention is the overall design and optimization of the frequency domain and power in order to adapt to actual changes in subscriber requirements. It allows dynamic regulations of line transmission direction and transmits power to achieve subscriber requirements for dynamic changes to upstream and downstream data rate.

Former technology did not consider the simultaneous use of upstream and downstream, whereas the present invention proposes considering the simultaneous use of upstream and downstream. Below, we specifically explain a mathematical model that the present invention proposes in order to resolve the problem of simultaneously using upstream and downstream.

When implementing power allocation and regulation, the following transmission channel model is used. In a communications model using discrete multi tone (DMT) with n subscribers and k TONES (subchannels), the transmission signal of each tone can be independently expressed as:

yₖ=Hₖxₖ+σₖ (1)

xₖ is the input vector of the k^{th} TONE, yₖ is the output vector of the k^{th} TONE, and xₖ and yₖ are both N dimension vectors. Hₖ is an N*N transmission matrix of the k^{th} TONE. If the m^{th} subscriber and n^{th} subscriber have the same direction on the k^{th} TONE, then hₖ^{n,m} is the far end crosstalk function; if the transmission directions are opposite, then hₖ^{n,m} is the near end crosstalk function. Supposing each modem regards interference from each other modem as noise, the data rate at which the n^{th} subscriber can achieve can be calculated using the Shannon channel capacity theorem:

$${b}_{k}^{n} = {log}_{2} ( 1 + \frac{{\vert {h}_{k}^{n , n} \vert}^{2} {s}_{k}^{n}}{{\sum }_{m \neq n} {\vert {h}_{k}^{n , m} \vert}^{2} {s}_{k}^{m} + {σ}_{k}^{n}} ) \qquad ( 2 )$$

Dynamic frequency spectrum management can be described as follows: The overall transmitted power of each online subscriber must satisfy definite limitations; the transmitted power on a single TONE must satisfy frequency spectrum density limitations. Stipulating upstream and downstream data rate for the 2^{nd} to the n^{th} subscriber must achieve a definite numerical value. The objective is to optimize the weighted upstream and downstream rate of the 1^{st} subscriber line. Limitations and objectives can be correspondingly regulated according to changes in actual requirements. The dynamic frequency spectrum management problem is to maximize target functional values under the precondition of satisfying the aforementioned limitations, by regulating the transmission direction and transmitting power for each TONE of each subscriber.

Using δ_{k,n}^{up} and δ_{k,n}^{down} to denote upstream and downstream transmission of the n^{th} subscriber on the k^{th} TONE, its adopted value is 0 or 1. δ_{k,n}^{up}=1 denotes upstream transmission, δ_{k,n}^{down}=1 denotes downstream transmission, the second satisfies δ_{k,n}^{up}+δ_{k,n}^{down}=1, namely each TONE can only transmit upstream or downstream at any one time; sₖⁿ is the power allocation of the k^{th} TONE, its obtained value must satisfy PSD mask limitations. Where,

$${h}_{k}^{n , m} = \{ \begin{matrix}{h}_{k , FEXT}^{n , m} , if ( {δ}_{k , m}^{up} = {δ}_{k , n}^{up} ) ; \\ {h}_{k , NEXT}^{n , m} , if ( {δ}_{k , m}^{up} \neq {δ}_{k , n}^{up} ) .\end{matrix} ,$$

namely, if transmission of the m^{th} subscriber and n^{th} subscriber on the k^{th} TONE are the same direction, then hₖ^{n,m} is the far end crosstalk function; if the transmission directions are opposite, then hₖ^{n,m} is the near end crosstalk function. Said function can be obtained through line physical characteristics and topological structure.

Consequently, the present invention proposes that a mathematical form for the DSM problem can be described as follows.

$${max}_{{s}_{1} , … , {s}_{N}} {w}_{1} {R}_{1}^{up} + {w}_{2} {R}_{1}^{down} \\ s . t . {R}_{n}^{up} \geq {R}_{n , up}^{target} , {R}_{n}^{down} \geq {R}_{n , down}^{target} , n = 2 , 3 , … , N \\ s . t . {\sum }_{k = 1}^{K} {s}_{k}^{n} \leq {P}_{n} , n = 1 , 2 , … , N \\ s . t .0 \leq {s}_{k}^{n} \leq {s}_{max} , k = 1 , … , K ; n = 1 , … , N \\ s . t . {δ}_{k , n}^{up} + {δ}_{k , n}^{down} = 1 , {δ}_{k , n}^{up} , {δ}_{k , n}^{down} ∈ \{ 0 , 1 \} , k = 1 , 2 , … K ; n = 1 , 2 , … N \\ where , \\ {R}_{n}^{up} = {\sum }_{k = 1}^{K} {b}_{k}^{n} {δ}_{k , n}^{up} , {R}_{n}^{down} = {\sum }_{k = 1}^{K} {b}_{k}^{n} {δ}_{k , n}^{down} ; \qquad ( 3 )$$

### R_{n,up}^{target}, R_{n,down}^{target}, Pₙ, w₁, w₂ and sₘₐₓ are all given constants;

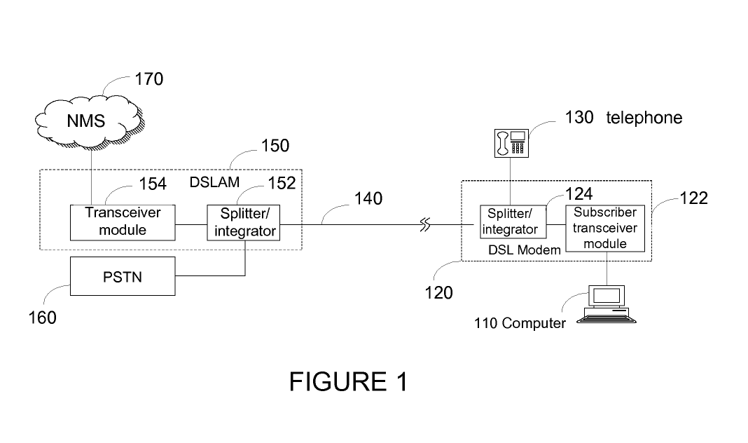

In the present invention, for DSM, the upstream and downstream transmission direction for any one TONE in the initialization phase can be determined according to the dynamic regulation of a subscriber's actual application, the upstream and downstream transmission direction is no longer fixed as in FIG. 1. Therefore, the optimization variables comprise δ_{k,n}^{up}, δ_{k,n}^{down} and sₖⁿ (k=1,2, . . . ,K; n=1,2, . . . ,N). Said model can be understood as DSM that permits upstream and downstream to share use of a frequency domain. This problem can be solved by using the pairing method, introducing Lagrange weight coefficients. Formula (3) can be transformed into:

$${max}_{{s}_{1} , … , {s}_{N}} {w}_{1} {R}_{1}^{up} + {w}_{2} {R}_{1}^{down} + {\sum }_{n = 2}^{N} ( {λ}_{n}^{up} {R}_{n}^{up} + {λ}_{n}^{down} {R}_{n}^{down} ) - {\sum }_{n = 1}^{N} {\sum }_{k = 1}^{K} {μ}_{n} {s}_{k}^{n} \\ s . t .0 \leq {s}_{k}^{n} \leq {s}_{max} , k = 1 , … , K ; n = 1 , … , N \\ s . t . {δ}_{k , n}^{up} + {δ}_{k , n}^{down} = 1 , {δ}_{k , n}^{up} , {δ}_{k , n}^{down} ∈ \{ 0 , 1 \} , k = 1 , 2 , … K ; n = 1 , 2 , … N \qquad ( 4 )$$

### Where,

sₖⁿ denotes the transmit power of the k^{th} TONE on the n^{th} subscriber line;
σₖⁿ denotes the noise signal received by the n^{th} subscriber on the k^{th} TONE; and
w₁ and w₂ are all given constants,
λₙ^{up}, λₙ^{down} and μₙ: are respectively Lagrange operators;
bₖ^{n,up} and bₖ^{n,down}: respectively denote the number of bits that can be carried upstream and downstream on the k^{th} TONE of the n^{th} subscriber line.
δ_{k,n}^{up} denotes whether the n^{th} subscriber of the k^{th} subchannel is upstream transmission, only when δ_{k,n}^{up}=1 denotes upstream transmission;
δ_{k,n}^{down} denotes whether the n^{th} subscriber of the k^{th} subchannel is downstream transmission, only when δ_{k,n}^{down}=1 denotes downstream transmission.

### Rₙ^{target} is the target line rate.

Formula (4) can be reduced and resolved as an independent target function of the k^{th} TONE, using Jₖ to denote the coefficient of the k^{th} TONE in Formula (4):

$${J}_{k} = {w}_{1} {b}_{k}^{1 , up} + {w}_{2} {b}_{k}^{1 , down} + {\sum }_{n = 2}^{N} ( {λ}_{n}^{up} {b}_{k}^{n , up} + {λ}_{n}^{down} {b}_{k}^{n , down} ) - {\sum }_{n = 1}^{N} {μ}_{n} {s}_{k}^{n} \qquad ( 5 )$$

where,
sₖⁿ denotes the transmit power of the k^{th} TONE on the n^{th} subscriber line;
w₁ and w₂ are given constants,
λₙ^{up}, λₙ^{down} and μₙ are respectively Lagrange operators;
bₖ^{n,up} and bₖ^{n,down}: respectively denote the number of bits that can be carried upstream and downstream on the k^{th} TONE of the n^{th} subscriber line.
δ_{k,n}^{up} denotes whether the n^{th} subscriber of the k^{th} subchannel is upstream transmission, only when δ_{k,n}^{up}=1 denotes upstream transmission;
δ_{k,n}^{down} denotes whether the n^{th} subscriber of the k^{th} subchannel is downstream transmission, only when δ_{k,n}^{down}=1 denotes downstream transmission.

Consequently, the maximum value of formula (5) can be obtained by enumerating all values of transmission direction and transmitting power for each TONE, then dynamically regulating each weighting coefficient value. This process is reiterated until each limit is satisfied and calculations converge.

From the above, it is clear that the present inventions uses the dual method in the derivation process from formulae (3) to (5) (See, Cendrillon, W. Yu, M. Moonen, J. Verlinden, and T. Bostoen, “Optimal multi-subscriber spectrum management for digital subscriber lines,” accepted by IEEE Transactions on Communications, 2005.) However, this invention proposes a new mathematic model. The difference between this invention and existing technology is that existing technology only considers power allocation in a fixed bandplan, and completely neglects to take into consideration shared use of the frequency domain by upstream and downstream. Consequently, the mathematical model in formula (3) is completely different from the mathematical model in existing technology.

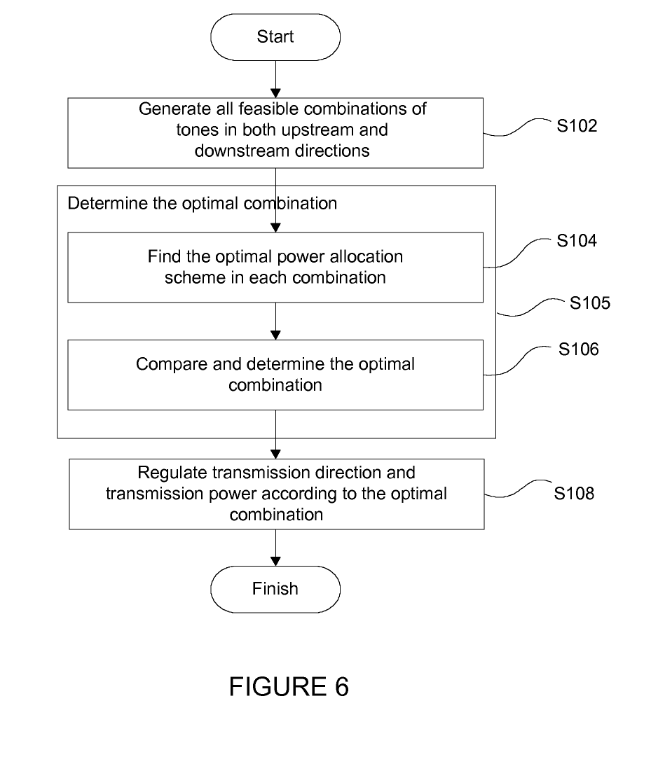

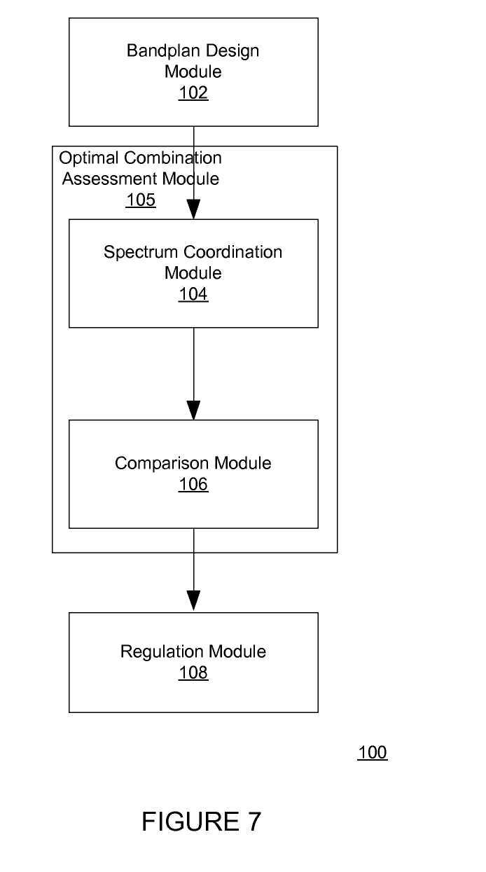

The present invention is proposed in accordance with the above analysis. The following refers to FIGS. 6 and 7 to describe in detail the method and device for xDSL upstream and downstream shared frequency dynamic frequency spectrum management.

FIG. 6 is a schematic diagram illustrating a method for xDSL upstream and downstream shared frequency dynamic frequency spectrum management according to the present invention; FIG. 7 is a schematic diagram illustrating an xDSL upstream and downstream shared frequency dynamic frequency spectrum management device (100).

As shown in FIG. 6, a method for xDSL upstream and downstream shared frequency dynamic frequency spectrum management, comprising the following steps:

Step S102, generate all feasible combinations of TONE in both upstream and downstream directions for an xDSL line;

Step S105, Determine which combination of said combinations has an optimal spectrum coordination; and

Step S108: adjust direction of transmission and transmit power of the xDSL line according to said optimal combination.

Optional, step S105 includes the following steps

Step S104, find the optimal power allocation scheme in each combination, wherein it is optional to construct the mathematic model

$${J}_{k} = {w}_{1} {b}_{k}^{1 , up} + {w}_{2} {b}_{k}^{1 , down} + {\sum }_{n = 2}^{N} ( {λ}_{n}^{up} {b}_{k}^{n , up} + {λ}_{n}^{down} {b}_{k}^{n , down} ) - {\sum }_{n = 1}^{N} {μ}_{n} {s}_{k}^{n} ,$$

of which, sₖⁿ denotes the transmit power of the k^{th} TONE in the n^{th} subscriber line; w₁ and w₂ are given fixed constants, λₙ^{up}, λₙ^{down} and μₙ are respectively Lagrange operators; bₖ^{n,up} and bₖ^{n,down} respectively denote the number of bits that can be carried in each of the upstream and downstream channels in the k^{th} TONE of the n^{th} subscriber line. Use said mathematical model to find the optimal power allocation scheme in each type of combination; and

Step S106, compare each of the optimal power allocation schemes, obtain the best power allocation scheme among the optimal power allocation schemes, and set the best power combination of the optimal power allocation schemes as optimal combination.

From the above method it can be seen that Step S102 is used to implement band planning, step 104 is used to implement spectrum coordination; from Step S102 to Step S106 integrates band planning and spectrum coordination, thus dynamically regulating line transmission direction and transmitting power according to actual subscriber requirements and achieving the subscriber's requirement for dynamic change to upstream and downstream data rate.

As shown in FIG. 7, an xDSL upstream and downstream shared frequency dynamic frequency spectrum management device (100) according to the present invention, comprising:

Bandplan Design Module (102), used to generate all feasible upstream and downstream TONE combinations for an xDSL line;

Optimal Combination Assessment Module (105), used to determine the optimal spectrum coordination combination from among the combinations; and

Regulation Module (108), used to modify the direction of transmission and transmit power according to said optimal combination.

Optionally, the optimal combination assessment module (105) comprises:

Spectrum Coordination Module (104), used to find the optimal power allocation scheme from each of the combinations; and

Comparison Module (106), used to compare each of the optimal power allocation schemes, obtain the best power combination among the optimal power allocation schemes, and set the best power combination of the optimal power allocation schemes as optimal combination spectrum.

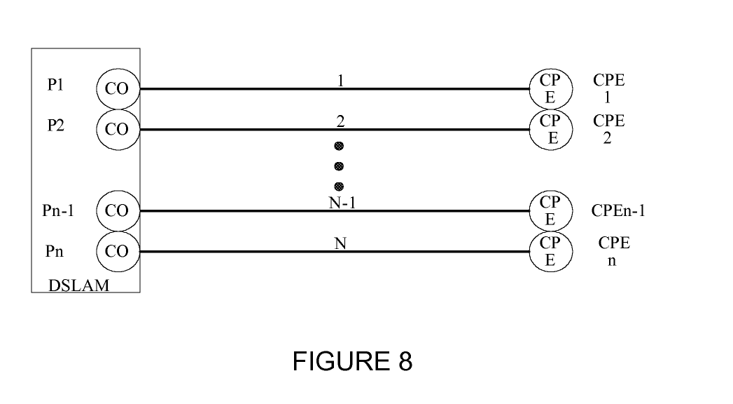

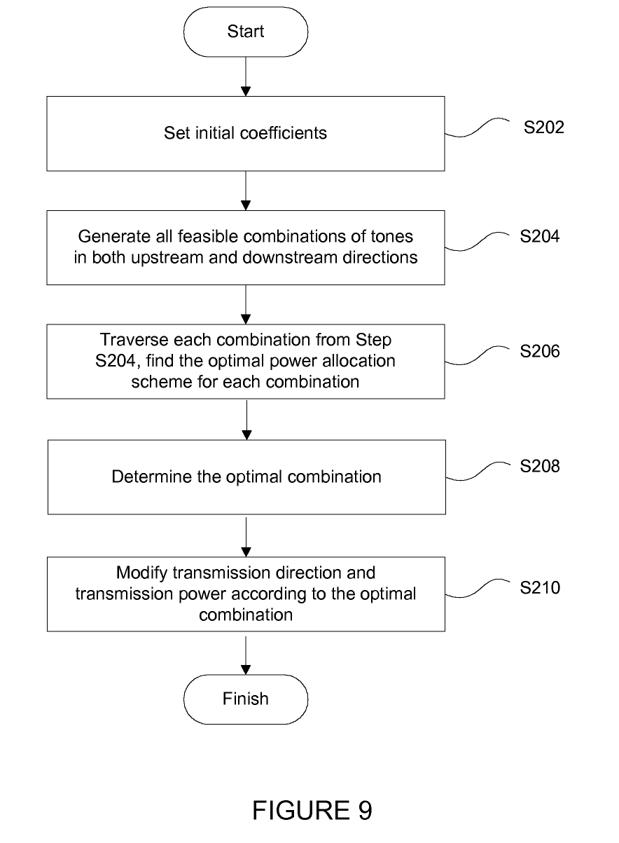

The following combines FIGS. 8 and 9 to describe in detail an implementation example for an xDSL upstream and downstream shared frequency dynamic frequency spectrum management method.

FIG. 8 is a schematic diagram illustrating an implementation example of a multi-subscriber environment for the present invention; and

FIG. 9 is a schematic diagram illustrating a method for xDSL upstream and downstream shared frequency dynamic frequency spectrum management for the multi-subscriber environment in FIG. 8;

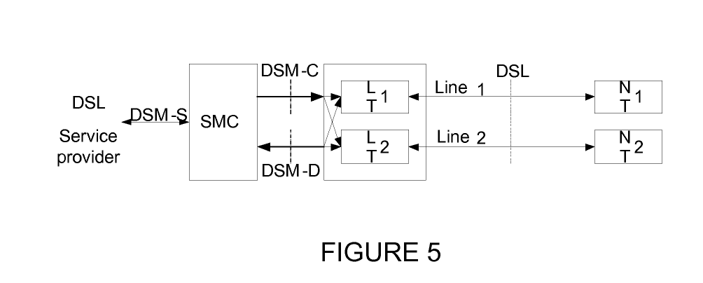

For the multi-subscribers case shown in FIG. 8, suppose that all connections are operating normally and each pair of transceivers already has a predetermined bit table value (B) and a PSD allocated for every tone. Here, we consider maximizing the upstream and downstream data rate weighting coefficient for the first line in FIG. 5. Therefore, FIG. 9 is a schematic diagram illustrating a method for xDSL upstream and downstream shared frequency dynamic frequency spectrum management for the multi-subscriber environment in FIG. 8, comprising the following steps:

Step S202: Initialize the following parameters:

λₙ^{up}, λₙ^{down} and μₙ, ε, power regulation interval δ, R_{n,up}^{target}, R_{n,down}^{target}, Pₙ, w₁, w₂ and sₘₐₓ

Step S204: Generate all feasible combinations of TONE in both upstream and downstream directions.

First, cycle the outermost layer, traverse each TONE combination in both upstream and downstream direction. That is, for all k=1, 2, . . . ,K and n=1,2, . . . ,N, traverse all combinations that satisfy δ_{k,n}^{up} and δ_{k,n}^{down}=1 and δ_{k,n}^{up}, ε{0,1};

Step S206: Traverse each upstream and downstream assembly in step S204, find the optimal power allocation scheme in each assembly;

Step S10: For each upstream and downstream combination in step S204, take TONE as the unit of iteration (from 1 to K), take δ as minimum interval and traverse all sₖⁿ (k=1, 2, . . . , K; n=1, 2, . . . , N), i.e. sₖⁿ can substitute values of (0, δ, 2δ, . . . , Sₘₐₓ), altogether making |sₘₐₓ/δ+1| substitutions. Find the power allocation scheme that maximizes Jₖ in formula (5). When calculating Jₖ, obtain the noise (σₖⁿ) of the k^{th} TONE and channel attenuation function hₖ^{n,n} according to specifications in the G.997.1 standard. Noise σₖⁿ comprises line background noise and crosstalk from other circuits. Carried bit rate can be calculated according to formula (2).

Step S20: when all TONES have been traversed, dynamically modify all weight coefficients according to the following formulae;

$${λ}_{n}^{up} = {[ {λ}_{n}^{up} + ɛ ( {R}_{n , up}^{target} - {R}_{n}^{up} ) ]}^{+} , n = 2 , … , N$$

$${λ}_{n}^{down} = {[ {λ}_{n}^{down} + ɛ ( {R}_{n , down}^{target} - {R}_{n}^{down} ) ]}^{+} , n = 2 , … , N$$

$${μ}_{n} = {[ {μ}_{n} + ɛ ( {\sum }_{k = 1}^{K} {s}_{k}^{n} - {P}_{n} ) ]}^{+} , n = 1 , … , N .$$

Repeat step S206 until all limiting conditions are satisfied and a stable state is achieved. When the value of each weighting coefficient in Step S20 remains unchanged, it denotes that allocation for the entire spectrum has achieved a stable state. At this point it can be taken that power allocation has achieved a point of equilibrium.

Step S208: Find the optimal combination:

Compare all the optimal power allocation schemes obtained in S206, obtain the best power combination among the optimal power allocation schemes, and set the best power combination of the optimal power allocation schemes as the optimal combination. Of these, the optimal scheme is the scheme that maximizes the objective function w₁R₁^{up}+w₂R₁^{down} in formula 5.

Step S210: Modify the line transmission direction and transmit power according to said optimal combination, thereby allowing dynamic regulation based on actual subscriber requirements.

From the above implementation example it can be seen that this invention guarantees the optimal power allocation by introducing Lagrange factors and adopting the dual method. In a situation where the number of subscribers is not overly large, this invention can be implemented effectively. In addition, calculations can be simplified through iteration, such as in the document R. Cendrillon and M. Moonen, “Iterative spectrum balancing for digital subscriber lines,” Proc. IEEE ICC, 2005, the document W. Yu, G. Ginis, and J. Cioffi, “Distributed multi-subscriber power control for digital subscriber lines,” IEEE Journal on Selected, Areas in Communication, vol. 20, no. 5, pp. 1105-1115, June 2002 and the ISB, IW and ASB methods found in the document J. Huang, R. Cendrillon and M. Chiang, “Autonomous spectrum balancing (ASB) for frequency selective interference channels”. For technical personnel in this area, the present invention can be easily extended to the above three methods.

In the above embodiments for implementation, it is taken that all subchannels can dynamically regulate transmission direction to achieve subscriber rate requirements. However, in practice, certain frequency ranges can be fixed and only a section of frequency ranges permitted to dynamically change transmission direction. This is also capable of satisfying subscriber requirements. Mathematical models and solutions can be simply extended by the scheme described in said implementation example, i.e. fixing the transmission direction of certain TONES. It is worth noting that the above implementation example is merely one specific example of the present invention and is in no way used to limit the present invention.

From the above description it can be seen that this invention achieves the following results:

The present invention provides an xDSL upstream and downstream shared frequency dynamic frequency spectrum management method and device that dynamically regulates line transmission direction and transmits power based on actual subscriber requirements through Bandplan Design and Spectrum Coordination. Subscriber requirements for dynamically changing upstream and downstream data rate are thereby achieved.

The aforementioned merely describes a preferred implementation of the present invention and is not used to circumscribe this invention in any way. For technical personnel in this area, the present invention may be modified and altered in a variety of ways. Any modification, equivalent substitution, and improvement etc. that fall within the spirit and principle of the present invention shall be contained within the scope of protection of the present invention.

1. A method for dynamic spectrum management of xDSL upstream and downstream shared frequency, characterized by comprising the following steps:
step a: generating all feasible combinations of subchannels in both upstream and downstream directions for an xDSL line;
step b: determining an optimal spectrum coordination combination from said combinations; and
step c: adjusting a transmission direction and a transmission power of said xDSL line according to said optimal combination.

2. The method for dynamic spectrum management of xDSL upstream and downstream shared frequency according to claim 1, wherein said step a comprises the following steps:
traversing all subscribers n=1, 2, . . . ,N and all subchannels k=1, 2, . . . , k in the upstream and downstream directions, finding out all combinations that satisfy δ_{k,n}^{up}+δ_{k,n}^{down}=1 and δ_{k,n}^{up}, δ_{k,n}^{down}ε{0,1}, said combinations serving as said feasible upstream and downstream combinations;
wherein, δ_{k,n}^{up} denotes whether the n^{th} subscriber on the k^{th} subchannel is an upstream transmission, δ_{k,n}^{up}=1 denotes the upstream transmission, δ_{k,n}^{up}=0 denotes a non-upstream transmission; δ_{k,n}^{down} denotes whether the n^{th} subscriber on the k^{th} subchannel is a downstream transmission, δ_{k,n}^{down}=1 denotes the downstream transmission, and δ_{k,n}^{down}=0 denotes a non-downstream transmission.

3. The method for dynamic spectrum management of xDSL upstream and downstream shared frequency according to claim 2, wherein said step b comprises the following steps:
step b1: finding an optimal power allocation scheme for each of said combinations; and
step b2: comparing all of said optimal power allocation schemes, obtaining the most optimal power allocation scheme, and determining a combination with said most optimal power allocation scheme as said optimal combination.

4. The method for dynamic spectrum management of xDSL upstream and downstream shared frequency according to claim 3, wherein said step b1comprises the following steps:
step 1: constructing a mathematical model
$${J}_{k} = {w}_{1} {b}_{k}^{1 , up} + {w}_{2} {b}_{k}^{1 , down} + {\sum }_{n = 2}^{N} ( {λ}_{n}^{up} {b}_{k}^{n , up} + {λ}_{n}^{down} {b}_{k}^{n , down} ) - {\sum }_{n = 1}^{N} {μ}_{n} {s}_{k}^{n} ,$$
wherein, sₖⁿ denotes a transmission power for the k^{th} subchannel on the n^{th} subscriber line; w₁ and w₂ are given constants, λₙ^{up}, λₙ^{down} and μₙ are respectively Lagrange operators; bₖ^{n,up} and bₖ^{n,down} respectively denote the number of bits that can be carried in the upstream direction and the downstream direction in the k^{th} subchannel on the n^{th} subscriber line; and
step 2: for all of said feasible combinations in the upstream and downstream directions, traversing all sₖⁿ from 1 to k, applying δ as a minimum traversing interval and a subchannel as a unit of recursion, wherein k=1, 2, . . . ,k and n=1, 2, . . . , N, finding through iteration a power allocation scheme that maximizes Jₖ and satisfies an overall power limitation of each subscriber line and a data rate limitation for each subscriber line, and determining the power allocation scheme as said optimal power allocation scheme.

5. The method for dynamic spectrum management of xDSL upstream and downstream shared frequency according to claim 4, wherein said step 2 comprises the following steps:
after completion of the traversing all said subchannels, dynamically modifying each weighting coefficient according to each of the following formulae:
$${λ}_{n}^{up} = {[ {λ}_{n}^{up} + ɛ ( {R}_{n , up}^{target} - {R}_{n}^{up} ) ]}^{+} , n = 2 , … , N , \\ {λ}_{n}^{down} = {[ {λ}_{n}^{down} + ɛ ( {R}_{n , down}^{target} - {R}_{n}^{down} ) ]}^{+} , n = 2 , … , N , \\ {μ}_{n} = {[ {μ}_{n} + ɛ ( {\sum }_{k = 1}^{K} {s}_{k}^{n} - {P}_{n} ) ]}^{+} , n = 1 , … , N ,$$
until satisfying the overall power for the each subscriber line and the data rate limitation for the each subscriber line and achieving a stable state, the obtained power allocation scheme being said power allocation scheme that maximizes Jₖ.

6. The method for dynamic spectrum management of xDSL upstream and downstream shared frequency according to claim 4, wherein said step 1 comprises the following steps:
when calculating the Jₖ, obtaining a subchannel noise σₖⁿ and a channel attenuation function hₖ^{n,n} for the kth subchannel; said noise σₙ^{k} including a background noise of said xDSL line and a crosstalk noise from other xDSL lines, the loading bit rate being calculated according to
$${b}_{k}^{n} = {log}_{2} ( 1 + \frac{{\vert {h}_{k}^{n , n} \vert}^{2} {s}_{k}^{n}}{{\sum }_{m \neq n} {\vert {h}_{k}^{n , m} \vert}^{2} {s}_{k}^{m} + {σ}_{k}^{n}} ) .$$

7. A device for dynamic spectrum management of xDSL upstream and downstream shared frequency, characterized by comprising:
a bandplan design module, used to generate all feasible combinations of subchannels in both upstream and downstream directions for an xDSL line;
an optimal combination determination module, used to determine an optimal spectrum coordination combination from said combinations; and
an adjustment module, used to adjust a transmission direction and a transmission power of said xDSL line according to said optimal combination.

8. The device for dynamic spectrum management of xDSL upstream and downstream shared frequency according to claim 7, wherein said bandplan design module traverses all subscribers n=1, 2, . . . ,N and all subchannels k=1, 2, . . . , k in the upstream and downstream directions, finds out all combinations that satisfy
δ_{k,n}^{up}+δ_{k,n}^{down}=1 and δ_{k,n}^{up}, δ_{k,n}^{down}ε{0,1}, said combinations serving as said feasible upstream and downstream combinations;
wherein, δ_{k,n}^{up} denotes whether the nth subscriber on the kth subchannel is an upstream transmission, δ_{k,n}^{up}=1 denotes the upstream transmission, δ_{k,n}^{up}=0 denotes a non-upstream transmission; δ_{k,n}^{down} denotes whether the nth subscriber on the kth subchannel is a downstream transmission, δ_{k,n}^{down}=1 denotes the downstream transmission, and δ_{k,n}^{down}=0 denotes a non-downstream transmission.

9. The device for dynamic spectrum management of xDSL upstream and downstream shared frequency according to claim 8, wherein said optimal combination determination module comprises:
a spectrum coordination module, used to find an optimal power allocation scheme for each of said combinations; and
a comparison module, used to compare all of said optimal power allocation schemes, obtain the most optimal power allocation scheme, and determine a combination of transmission directions with said most optimal power allocation scheme as said optimal combination.

10. The device for dynamic spectrum management of xDSL upstream and downstream shared frequency according to claim 9, wherein said spectrum coordination module comprises:
a model construction module, used to construct a mathematical model
$${J}_{k} = {w}_{1} {b}_{k}^{1 , up} + {w}_{2} {b}_{k}^{1 , down} + {\sum }_{n = 2}^{N} ( {λ}_{n}^{up} {b}_{k}^{n , up} + {λ}_{n}^{down} {b}_{k}^{n , down} ) - {\sum }_{n = 1}^{N} {μ}_{n} {s}_{k}^{n} ,$$
wherein, sₖⁿ denotes a transmission power for the k^{th} subchannel on the n^{th} subscriber line; w₁ and w₂ are given constants, λₙ^{up}, λₙ^{down} and μₙ are respectively Lagrange operators; bₖ^{n,up} and bₖ^{n,down} respectively denote the number of bits that can be carried in the upstream direction and the downstream direction in the k^{th} subchannel on the n^{th} subscriber line; and
a traversing module, used to, for all of said feasible combinations in the upstream and downstream directions, traverse all sₖⁿ from 1 to k, applying δ as a minimum traversing interval and a subchannel as a unit of recursion, wherein k=1, 2, . . . ,k and n=1, 2, . . . , N, find through iteration a power allocation scheme that maximizes Jₖ and satisfies an overall power limitation of each subscriber line and a data rate limitation for each subscriber line, and determine the power allocation scheme as said optimal power allocation scheme.

11. The device for dynamic spectrum management of xDSL upstream and downstream shared frequency according to claim 10, wherein said traversing module is also used to, after completion of the traversing all said subchannels, dynamically modify each weighting coefficient according to each of the following formulae:
$${λ}_{n}^{up} = {[ {λ}_{n}^{up} + ɛ ( {R}_{n , up}^{target} - {R}_{n}^{up} ) ]}^{+} , n = 2 , … , N , \\ {λ}_{n}^{down} = {[ {λ}_{n}^{down} + ɛ ( {R}_{n , down}^{target} - {R}_{n}^{down} ) ]}^{+} , n = 2 , … , N , \\ {μ}_{n} = {[ {μ}_{n} + ɛ ( {\sum }_{k = 1}^{K} {s}_{k}^{n} - {P}_{n} ) ]}^{+} , n = 1 , … , N ,$$
until satisfying the overall power for the each subscriber line and the data rate limitation for the each subscriber line and achieving a stable state, the obtained power allocation scheme being said power allocation scheme that maximizes Jₖ.

12. The device for dynamic spectrum management of xDSL upstream and downstream shared frequency according to claim 10, wherein said model construction module, when calculating Jₖ, obtains a subchannel noise σₖⁿ and a channel attenuation function hₖ^{n,n} for the k^{th} subchannel; said noise σₖⁿ including a background noise of said xDSL line and a crosstalk noise from other xDSL lines, the loading bit rate being calculated according to
$${b}_{k}^{n} = {log}_{2} ( 1 + \frac{{\vert {h}_{k}^{n , n} \vert}^{2} {s}_{k}^{n}}{{\sum }_{m \neq n} {\vert {h}_{k}^{n , m} \vert}^{2} {s}_{k}^{m} + {σ}_{k}^{n}} ) .$$
